(19) United States
(12) Patent Application Publication
(10) Pub. No.: US 2026/0189942 A1
(43) Pub. Date: Jul. 2, 2026

(54) COMMUNICATIONS SYSTEM, MORE PARTICULARLY 5G SYSTEM

(71) Applicant: Robert Bosch GmbH, Stuttgart (DE)

(72) Inventors: David Osamu Ginthoer, Stuttgart (DE); Henrik Klessig, Renningen (DE); Matthias Ruther, Karlsruhe (DE); Rene Guillaume, Boeblingen (DE)

(21) Appl. No.: 18/856,768

(22) PCT Filed: Jun. 15, 2023
(86) PCT No.: PCT/EP2023/066050

§ 371 Date: Oct. 14, 2024

(30) Foreign Application Priority Data
Jun. 24, 2022 (DE) 10 2022 206 399.6

(51) Int. Cl. H04W 24/08; H04W 24/02; H04W 28/06; H04W 76/20

(52) U.S. Cl. CPC H04W 24/08; H04W 24/02; H04W 28/06; H04W 76/20

(57) ABSTRACT

A communications system, more particularly a 5G system. The system includes an access network, at least two end nodes, a first communication subscriber, a second communication subscriber, a user plane function and a function including a superordinate control function for operating the communications system.

### FIELD

The present invention relates to a communications system, more particularly a 5G system

### BACKGROUND INFORMATION

Radio networks in industrial or automotive environments, where reliability, security and confidentiality of transmission are essential requirements and changes in the environment usually influence the transmission features, require a dynamic adjustment of the network to the currently prevailing conditions. Therefore, technologies, such as Software-Defined Networking (SDN), Time-Sensitive Networking (TSN) and 5G, take into account mechanisms to configure the network based on the communication requirements of the applications, the current transmission features and the available transmission resources.

Modern transmission systems, such as 5G networks, allow mobile devices not only to communicate with one another via a base station, but also to establish a direct link to one another. Under the name NR Sidelink, this feature was introduced in 3GPP Release 16, primarily having a focus on V2X. Release 17 included enhancements that allow better resource sharing and higher data rates. However, such a connection is still coordinated by the base station. This is shown by way of example in FIG. 1.

The mobile terminals ME1 and ME2, hereinafter referred to as communication subscribers, can communicate with one another either via the base station 1 and User Plane Function (UPF) 2 and thus exchange data with one another or via a direct connection 3.

In addition, as part of the ongoing standardization of TSN and 5G, mechanisms are required that allow the integration of 5G into a TSN network. 3GPP TS 23.700-20 describes, among other things, how different (TSN) endpoints can communicate with one another via such a logical 5G switch. FIG. 2 shows a communications system having a UPF 2 to which ME1 and ME2 can establish connections. As shown in FIG. 2, the end nodes E1 and E2 are provided to be connected to ME1 and ME2. The UPF 2 is used for communication between one another. Central User Configuration (CUC) and Central Network Configuration (CNC) represent management functions according to the TSN standardization.

### SUMMARY

For use in an industrial or automotive environment with mostly time-critical applications, various transmission features, such as very short latency, very high availability and efficient use of the available resources, are of particular importance.

According to the present invention, it is proposed to use further degrees of freedom for continuous adjustment of the radio transmission and thus to counteract the varying transmission features. In particular, according to an example embodiment of the present invention, the reliability of the radio transmission is to be increased by the parallel use of both a direct connection between the communication subscribers and a conventional connection via the base station and UPF. In addition, an optimization function as part of a superordinate network management instance can decide whether a direct connection between the communication subscribers or a connection via a base station and UPF is used in certain parts of the network.

The advantages are:
Increased reliability and availability through proactive activation and use of redundant connections and communication paths,
Efficient distribution of transmission resources by considering and prioritizing other communication subscribers,
More efficient use of transmission resources and reduction of interference by optimizing transmission performance,
Optimization of transmission features (e.g., latency or bandwidth) by comparing and selecting parallel communication paths.

According to an example embodiment of the present invention, a communications system, more particularly a 5G system, is proposed having at least the following components: an access network (RAN), at least a first end node E1, a second end node E2, a first communication subscriber and a second communication subscriber, a user plane function (UPF) and a superordinate control function for operating the communications system.

According to an example embodiment of the present invention, advantageously, the communications system comprises an optimization function for operating the communications system. Thus, the current transmission features in the network can be advantageously addressed, and an optimization of data transmission, e.g. by selecting an appropriate communications channel, can be effected.

According to an example embodiment of the present invention, advantageously, the communications system comprises two end nodes, wherein the end nodes are connected to the network via corresponding interfaces provided by the communications system.

The first end node communicates with the second end node, wherein a connection is advantageously established via the communications system.

According to an example embodiment of the present invention, it is proposed that a connection is established via a first communication path by direct communication between the two communication subscribers and/or that a connection is established via a second communication path via the base station and UPF. Thus, increased reliability and availability can be advantageously ensured.

If the optimal configuration of communication path 1 and communication path 2 is calculated by the optimization function, increased reliability and availability can be ensured.

According to an example embodiment of the present invention, it is proposed that the input variables underlying the optimization to be performed comprise at least the following parameters:
Requirements for the communications connection between the end nodes,
Limitations or requirements of the manually specified system configuration,
Distribution and/or positions of communication subscribers,
In the case of mobile communication subscribers, their movement profiles,
Availability of communications resources,
Transmission features along different communication paths,
Transmission statistics for individual connections.

According to an example embodiment of the present invention, advantageously, upon the recognition of a successful transmission via communication path 1, the second data packet is discarded before the second data packet is sent via communication path 2. Thus, an efficient distribution and use of available communications resources is advantageously ensured.

The optimization function compares the transmission features of communication path 1 and communication path 2. Based on the current transmission features of the two communication paths, transmission features, such as latency, reliability or data rate, can be advantageously optimized by selective transmission over one or both communication paths.

In a further embodiment of the present invention, the communications system comprises a controller, wherein the controller comprises a monitoring function that collects information provided by the communications system.

According to an example embodiment of the present invention, advantageously, the controller comprises a requirement database, in which the requirements are stored.

For example, in a 3GPP 5G system, the controller can be part of the 5G system and receives the requirements via available interfaces, such as the Application Function (AF). In another embodiment, the controller can be outside the 5G system. The transmission features over the relevant communication paths are provided to the controller by the Network Exposure Function (NEF), for example. The result of the optimization must be passed back to the 5G system, e.g. via the AF.

According to an example embodiment of the present invention, it is proposed that the monitoring function and the requirement database provide input variables to an optimization logic in the form of at least one piece of information.

According to an example embodiment of the present invention, advantageously, the optimization logic calculates the best possible combination of communication via the first communication path through direct communication between the two communication subscribers or via a second communication path via the base station and UPF.

Furthermore, according to an example embodiment of the present invention, a method for monitoring a communications system is proposed having at least the following steps:
Monitoring of the communications system by the controller, wherein the controller continuously collects information about the communications system and possible changes, e.g. of transmission features,
Review of the requirements and limitations along with possible changes to the requirements and limitations in the communications system by the controller,
Calculation of a suitable solution through the optimization logic in case of relevant changes or adjustments. If the current configuration needs to be adjusted, the optimization function passes the result to the communications system (if no adjustment is required, the monitoring of the communications system continues without further action),
Adjustment of the communications system according to the result of the previous step.

Further advantages are taken from the description of figures.

### BRIEF DESCRIPTION OF THE DRAWINGS

FIG. 1 shows a communications system under the related art without UPF.

FIG. 2 shows a communications system under the related art with UPF.

FIG. 3 shows a communications system according to an example embodiment of the present invention in schematic representation.

FIG. 4 shows an extension of the communications system in schematic representation, according to an example embodiment of the present invention.

FIG. 5 shows a method according to an example embodiment of the present invention for monitoring the communication system.

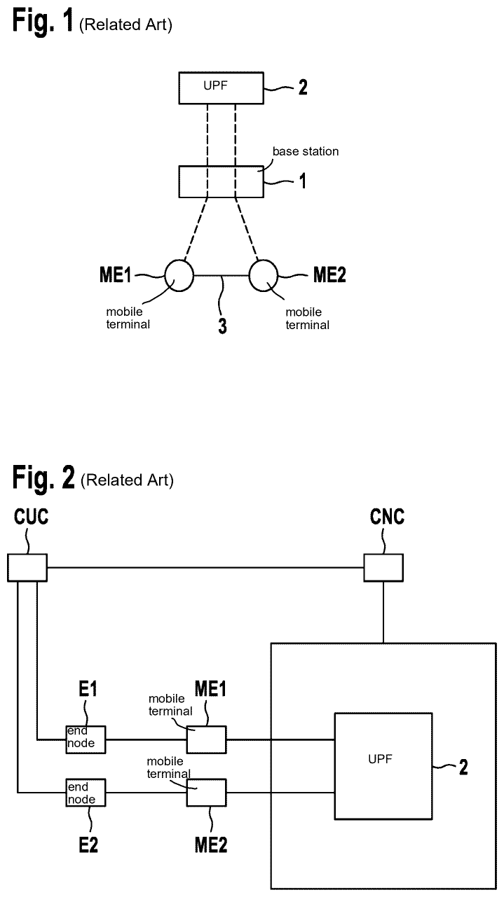

### DETAILED DESCRIPTION OF EXAMPLE EMBODIMENTS

The same reference numbers are used for the same components occurring in the different exemplary embodiments.

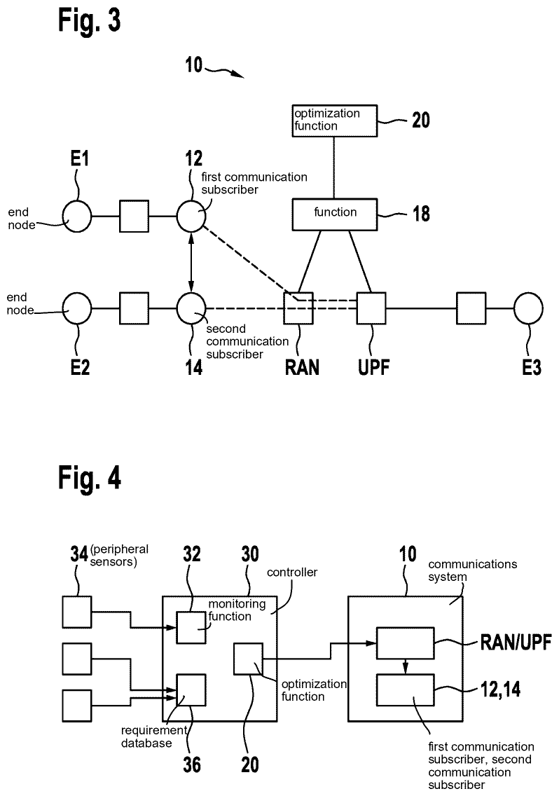

FIG. 3 schematically shows a communications system 10. The communications system 10 is designed as a radio network, more particularly as a 5G system.

By way of example, the communications system 10 comprises an access network (radio access network, RAN), two end nodes E1 and E2, a first communication subscriber 12, a second communication subscriber 14, a user plane function (UPF) and a function 18, in particular a superordinate control function, for operating the communications system 10.

Here, the control function 18 is the sum of the functions that control or regulate the data transmission. For example, the control function regulates data transmission with regard to data rate and latency requirements.

Furthermore, the communications system 10 comprises an optimization function 20 for operating the communications system 10. The optimization function 20 can be part of other management and control instances. The optimization function complements existing functions of the control function.

It is possible that the communications system 10 is designed as a logical TSN (Time-Sensitive Networking) switch. In this case, the end nodes E1 and E2 are connected to the network via corresponding interfaces provided by the communications system.

This has the following advantages:
more predictable end-to-end latencies,
more limited latency fluctuations
lower packet loss.
higher availability

In the case of industrial applications, the communication subscribers and the end nodes can be part of, for example, mobile devices, mobile control units or control panels or correspond to infrastructure components. However, the communication subscribers and end nodes can also be integrated into different physical components.

According to the present invention, the first end node E1 communicates with the second end node E2. A connection is established via the communications system 10.

The connection must have certain features, such as low packet loss rate, high bandwidth or latency.

According to the present invention, it is provided that a connection is established via a first communication path (communication path 1) by direct communication between the two communication subscribers 12, 14 or via a second communication path (communication path 2) via the UPF. This may result in fluctuations in the transmission features. It can be assumed that the communications system 10 knows the minimum required transmission features.

In the event of integrating 5G into a TSN system, the management functions CUC and CNC provide the minimum required transmission features. For example, the 5G system receives the information via the TSN Application Function (TSN AF) or Network Exposure Function (NEF) described by 3GPP. Alternatively, it is possible that the requirements of the end nodes are specified manually by a system administrator.

On the basis of available context information and requirements, the optimal configuration of communication path 1 and communication path 2 is calculated by the optimization function. The input variables underlying the optimization to be carried out are either known or measured. These can be, wherein the list is not exhaustive:
Requirements for the communications connection between the end nodes,
Limitations or requirements of the manually specified system configuration,
Distribution and/or positioning of communication subscribers,
Availability of communications resources,
Transmission features along different communication paths,
Transmission statistics for individual connections.

The following optimization goals can be considered, wherein the list is not exhaustive:
Increased reliability and availability through redundancy,
Efficiency in the distribution of transmission resources through joint consideration and prioritization of communication subscribers,
Efficiency in the use of transmission resources by optimizing transmission performance,
Optimization of transmission features, such as latency or bandwidth, through parallel communication paths.

One of the goals, for example, is the efficient distribution and use of available communications resources. Two use cases must be distinguished:
a) For direct communication between the two communication subscribers 12, 14, the same resource pool is used for direct connections analogous to communication path 1 as for connections via the UPF analogous to communication path 2. The distribution of transmission capacities from the common resource pool for communication paths 1 and 2 is planned and coordinated by the optimization function 20. In the event that the optimization logic is internal to the 3GPP system and has access to the RAN, it can directly plan the resources of the radio cell and allocate them accordingly. In the event that the optimization logic lies outside the 3GPP system, appropriate interfaces must be available to influence the RAN upon resource planning. For example, it is possible to book a communication service via the corresponding communication paths having dedicated requirements. If the service cannot be provided according to requirements, the 3GPP system could provide alarm notifications via the NEF, after which the optimization logic can adjust or select the communication paths. The advantage of direct communication between the two communication subscribers 12, 14 has the advantage of short transmission distances. Thus, the transmission performance and thus the risk of interference can be lower.
b) A dedicated resource pool is used for direct communication between the two communication subscribers 12, 14. Connections between communication subscribers in a confined space are characterized by mutual interference. Depending on the location and distribution of the communication subscribers, it may be sensible to use communication path 2 instead of communication path 1. This approach is more in line with the 5G standard, which includes dedicated channels, such as the Physical Sidelink Shared Channel (PSSC) and Physical Sidelink Control Channel (PSCC). The present invention differs from the standard by the presence of an optimization logic that influences the choice of the communication paths to be used.

A further goal is reliable transmission (e.g., through the use of redundancy) while simultaneously conserving transmission resources. However, the consumption of resources can be disadvantageous due to a continuous redundant design of the communications system. The simplest case of a redundant design is that data packets are sent duplicated via both communication path 1 and communication path 2. This corresponds to the Packet Duplication (PD) approach defined in conjunction with Dual Connectivity (DC) for Release 16 for URLLC applications. Here, the simultaneous transmission over two 5G NR connections is utilized in order to increase reliability. The present invention provides, among other things, an extension of this method for NR+D2D compounds.

According to the present invention, various methods can be used in order to reduce resource consumption. For example, data packets sent over the first communication path (communication path 1) typically have a shorter latency than data packets sent over the second communication path (communication path 2). If a successful transmission via communication path 1 is recognized before the second redundant data packet is sent from the UPF to the receiver via communication path 2, the second redundant packet can be discarded. Thus, the saved transmission resources can be used for other subscribers in the network.

The recognition of a successful data transmission is effected as follows:
Sending of a data packet from the first communication subscriber 12 to the second communication subscriber 14 via communication path 1
Simultaneous sending of the data packet from the first communication subscriber 12 to the second communication subscriber 14 via communication path 2
If the data packet is received successfully, the second communication subscriber 14 sends information to the RAN or the UPF
Preventing of the forwarding of the second redundant data packet by RAN or UPF to communication subscriber 14 on the basis of the information received by the RAN or UPF from communication subscriber 14

The information of the second communication subscriber 14 to RAN and/or UPF prior to forwarding the second data packet can be received as follows:
the transmission of data via communication path 1 and the transmission of information from communication subscriber 14 to RAN/UPF are, in their entirety, shorter than the data transmission from communication subscriber 12 to RAN/UPF.
the transmission of data via communication path 1 and the transmission of information opposite to communication path 1 and further from communication subscriber 12 to RAN/UPF are, in their entirety, shorter than the data transmission from communication subscriber 12 to RAN/UPF.

Another possibility is to aim for redundancy only for application-critical data packets. If the optimization function 20 has at least one transmission statistic of at least one connection as an input variable, a redundancy decision can be made by evaluating the statistics. If certain connections are susceptible to packet loss, a redundant transmission over communication path 1 and communication path 2 can be proactively initiated. Thus, simultaneous use of communication path 1 and communication path 2 can be configured, or depending on current transmission features, a dynamic switch between the communication paths can be performed. Furthermore, dynamic redundancy can be applied, with which redundant transmission over both communication paths is activated or deactivated depending on the current state of the application. Requirements with regard to redundancy can also be specified in the requirements database, for example.

For optimizing the transmission features, such as latency, reliability or data rate, the optimization function 20 compares the transmission features of communication path 1 and communication path 2.

If the quality of the mobile radio channel changes, one of the communication paths may no longer be able to meet the requirements of the application for the communications system, such as latency, reliability and data rate. In this case, a switch to the other communication path can be made. Example:

Communication path 1 cannot meet the latency, reliability and/or data rate requirement due to poor radio channel quality. In this case, communication path 2 is used.

Switching between communication paths is also possible in order to meet varying latency requirements of the application. For example, if the application allows just enough retransmission within the delay budget, communication path 1 could be used with high priority for retransmission in the event of a packet loss. Since this has a much lower latency than communication path 2, the probability of a successful transmission of the packet within the delay budget could be increased.

It is possible that the switching of communication paths or the addition of communication paths takes place depending on the transmission quality. As soon as the transmission quality of a communication path falls below a non-critical threshold, an additional communication path can be added or an alternative communication path can be selected.

FIG. 4 shows an extension of the communications system in a schematic representation. The system comprises the communications system 10 and at least one controller 30. The controller 30 can be implemented as a part or separate component of the 5G management system.

The controller 30 comprises a monitoring function 32. The monitoring function 32 collects the information provided by the communications system 10. Furthermore, data from peripheral sensors 34 are also collected. The data contain information about the current and predicted state of the communications system 10 along with system-relevant statistics. The controller 30 also comprises a requirement database 36. Specified requirements are stored in the requirement database 36.

The monitoring function 32 and the requirement database 36 provide an optimization function 20 having input variables in the form of at least one piece of information. The optimization function 20 calculates the best possible combination of communication via a first communication path (communication path 1) through direct communication between the two communication subscribers 12, 14 or via a second communication path (communication path 2) via the base station and UPF.

The optimization can be supported by AI-based algorithms. The result of the optimization function 20 is passed to the communications system 10, which manages the transmission resources.

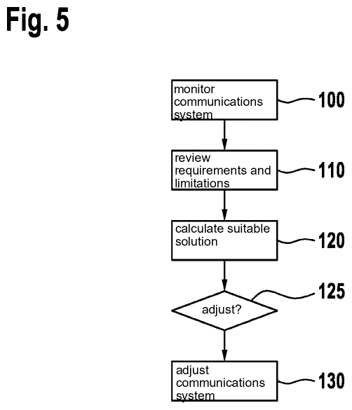

FIG. 5 shows a method in schematic representation having at least the following steps:
Monitoring of the communications system 10 by the controller 30, wherein the controller 30 continuously collects information about the communications system 10 and possible changes (step 100)
Review of the requirements and limitations along with possible changes to the requirements and limitations in the communications system 10 by the controller 30 (step 110),
Calculation of a suitable solution by the optimization logic in case of relevant changes or adjustments (120) (if the current configuration has to be adjusted, the function passes the result to the communications system 10. If no adjustment is required, monitoring of the communications system continues without further action),
Adjustment of the communications system 10 according to the result from the previous step (130).

1-16. (canceled)

17. A communications system, comprising:
an access network (RAN);
at least two end nodes;
a first communication subscriber;
a second communication subscriber;
a user plane function (UPF); and
a function including a superordinate control function for operating the communications system.

18. The communications system according to claim 17, wherein the communication system is a 5G system.

19. The communications system according to claim 17, wherein the communications system further comprises an optimization function for operating the communications system.

20. The communications system according to claim 17, wherein a first end node of the at least two end nodes communicates with a second end node of the at least two end nodes, wherein a connection is established via the communications system.

21. The communications system according to claim 20, wherein a connection is established via a first communication path by direct communication between the first and second communication subscribers.

22. The communications system according to claim 21, wherein a connection is established via a second communication path via the UPF.

23. The communications system according to claim 22, wherein an optimal configuration of first communication path and the second communication path is calculated by an optimization function and is continuously adjusted to current system states

24. The communications system according to claim 23, wherein input variables underlying the optimization to be carried out includes at least one of the following parameters:
requirements for the communications connection between the at least two end nodes,
limitations or requirements of the configuration,
distribution and/or positions of communication subscribers,
availability of communications resources,
transmission features along different communication paths,
transmission statistics for individual connections.

25. The communications system according to claim 22, wherein upon recognition of a successful transmission via the first communication path, a second data packet is discarded before the second data packet is forwarded via the second communication path by the UPF.

26. The communications system according to claim 25, wherein the recognition of a successful data transmission occurs as follows:
sending a data packet from the first communication subscriber to the second communication subscriber via the first communication path;
simultaneous sending of the data packet from the first communication subscriber to the second communication subscriber via the communication path;
when the data packet is received successfully, the second communication subscriber sends information to the RAN or the UPF,
preventing of the forwarding of a second redundant data packet by RAN and/or UPF to the second communication subscriber based on information received by the RAN or the UPF from communication subscriber.

27. The communications system according to claim 26, wherein the information of the second communication subscriber to the RAN and/or the UPF can be received as follows prior to forwarding the second data packet:
transmission of data is effected via the first communication path and transmission of information is effected from the second communication subscriber to RAN and/or UPF,
transmission of data is effected via the first communication path and transmission of information is effected opposite to the first communication path and further from the first communication subscriber to RAN and/or UPF.

28. The communications system according to claim 19, wherein for optimizing the transmission features including latency or reliability or data rate, the optimization function compares the transmission features of the first communication path and the second communication path.

29. A communications system, comprising at least one controller, wherein the controller includes a monitoring function that collects information provided by the communications system.

30. The communications system according to claim 29, wherein the controller includes a requirement database, wherein specified requirements are stored in the requirement database.

31. The communications system according to claim 29, wherein the monitoring function and the requirement database provide an optimization function having input variables in the form of at least one item of information.

32. The communications system according to claim 29, wherein optimization logic calculates the best possible combination of communication via a first communication path through direct communication between two communication subscribers, or via a second communication path via a user plane function (UPF).

33. A method for monitoring a communications system having at least the following steps:
monitoring the communications system by a controller, wherein the controller continuously collects information about the communications system and possible changes;
reviewing of requirements and limitations along with possible changes to the requirements and limitations in the communications system by the controller;
calculating a suitable solution through optimization logic in case of relevant changes or adjustments,
adjusting the communications system according to a result of the calculating step.
